(19) United States
(12) Patent Application Publication
(10) Pub. No.: US 2014/0232290 A1
(43) Pub. Date: Aug. 21, 2014

(54) MULTI-POWER LEVEL COMPACT FLUORESCENT LAMP ASSEMBLY

(71) Applicant: GENERAL ELECTRIC COMPANY, Schenectady, NY (US)

(72) Inventors: Jacint Gergely, Budapest (HU); Norbert Zoltan Benko, Budapest (HU); Peter Lucz, Budapest (HU); Gabor Szabo, Budapest (HU); Lorand Lehel Toth, Budapest (HU); Roland Rolle, East Cleveland, OH (US)

(73) Assignee: GENERAL ELECTRIC COMPANY, Schenectady, NY (US)

(21) Appl. No.: 13/768,053

(22) Filed: Feb. 15, 2013

(51) Int. Cl. H05B 37/02; F21V 23/04

(52) U.S. Cl. CPC H05B 37/02; F21V 23/04
USPC 315/291; 362/363

(57) ABSTRACT

Provided is a light assembly including a bulb, a lamp base enclosure having circuitry therein configured to supply power to the bulb, and an integrated and dial electrically coupled to the bulb and the lamp base. The dial is operable for selecting one of a plurality of predetermined power settings for the light assembly prior to installation.

### FIELD OF THE INVENTION

The present invention relates generally to fluorescent lamps. More particularly, the present invention relates to controlling the output wattage of compact fluorescent lamps (CFLs).

### BACKGROUND OF THE INVENTION

Conventional light bulbs provide only one wattage or lumen setting for light output. This can be particularly problematic given the number of different light fixtures in modern homes and the different requirements for light output and lumen requirements associated with these light fixtures. To satisfy these requirements, many consumers maintain an ample supply of different wattage bulbs.

Additionally, many lighting fixtures are restricted to bulbs of a particular wattage, or to bulbs that do not exceed a particular wattage. By way of example, if a consumer has a small table reading lamp that requires a 60 watt (W) incandescent bulb, and the bulb burns out, it must be replaced by another 60 W incandescent bulb. Although the consumer may have a supply of 25 W, 75 W, and 100 W light bulbs, none of these bulbs will suffice as a suitable replacement for the 60 W bulb. The 25 W bulb is suboptimal for reading, and is therefore an inadequate replacement. The 75 W and 100 W bulbs would also not be suitable replacements since they exceed the maximum wattage of the table lamp. The consumer's only option would be to purchase another 60 W bulb for the reading lamp despite having many other bulbs of different wattages. Retailers face a dilemma similar to the consumer.

Retailers are required to carry inventory levels for many different bulbs at different wattages to accommodate lighting fixtures having different wattage requirements. This prevents the retailer from being able to consolidate their inventory and optimize shelf space for new products. Also, each bulb requires its own stock keeping unit (SKU), which adds a layer of complexity to managing the multiple inventory levels for the different bulbs.

In addition to selecting bulbs having an appropriate wattage, many consumers search for bulbs having different colour temperatures to match or accent various color levels within their environment. The limited wattage settings of conventional light bulbs require the consumer, and correspondingly the retailer, to keep on hand different bulbs for different colour temperature requirements.

One solution to these dilemmas includes three-way (3-wattage) bulbs. Three-way bulbs, for example, are capable of operating at three different wattage levels. Three-way bulbs, however, and similar configurations, are operable only in lighting fixtures with three correspondingly different socket configurations.

Other solutions offer bulbs, such as CFLs, equipped with dimmers. For example, some CFL's include a knob that provides a dimming capability within the light bulb itself As understood by those of skill in the art, these dimming CFL's are screwed into sockets and their wattage is increased or decreased by turning the knob. Dimming CFL's, however, do not solve the challenges above associated with lighting fixtures that require bulbs of specific wattages. Also, dimming CFL's can also be quite expensive.

### SUMMARY OF EMBODIMENTS OF THE INVENTION

Given the aforementioned deficiencies, a need exists for an integrated lighting solution that (a) can be set for several lumen or wattage levels of light output before installation and (b) addresses the consumer desire for lighting control and flexibility. A need also exists for a lighting solution that can accommodate different colour temperature requirements of present-day lighting fixture consumers. Finally, a need exists to simplify the offering and inventory point-of-sale challenges associated with retailers required to stock multiple bulbs for the multiple wattages offered in commercially available lighting fixtures.

Embodiments of the present invention provide a light assembly including a bulb, a lamp base enclosure having circuitry therein configured to supply power to the bulb, and a dial electrically coupled to the bulb and the lamp base. The dial is operable for selecting one of a plurality of predetermined power settings.

In the embodiments, an integrated dial feature allows a spiral CFL to be set for several lumen levels of light output before installation. The consumer can adjust the preferred lamp wattage with a small switch. The switch connects the different outputs of an autotransformer to a load. This transformer is the resonant inductor and the current limiter of the ballast and has several different output levels. The output levels determine the lamp output wattage.

Lighting systems constructed in accordance with the embodiments offer the advantage of enabling a consumer to more flexibly purchase and stock replacements lamps. Flexibility, for example, is achieved since the consumer can use one lamp to replace up to four lamps if having previously stocked all four lumen, or wattage, levels.

On the retail side, the embodiments help simplify inventory and point-of-sale by allowing for expanded wattage range offerings. More particularly, using exemplary embodiments of the present invention, there is an ability to capture a multi-feature setting within an individual bulb. Also the retailers would no longer be required to carry multiple inventory levels for each wattage—enabling them to consolidate their inventory and save space for other new items. More specifically, the retailer can more easily manage their inventory and shelf space by consolidating three different wattages into one SKU instead of having to stock multiple packages.

With respect to an individual CFL, the embodiments provide a single lamp capable of running, for example, at 13 W, 20 W, and 23 W. 23 W provides the luminance level output equivalent to 100 W. With a dial on the housing of the CFL lamp itself, as provided in one of the embodiments, three different lumen levels can be accessed.

Using the same approach, consider the example of a 100 W incandescent light bulb burning out in a floor lamp being used by the consumer to read the newspaper or other books. The consumer would simply go to their pantry, open it up, and use another variable luminance spiral, identical to the one in the preceding example, albeit it at a different luminance setting. Once removed from the box, the dial on the variable lumen spiral can be set to the 100 W equivalent (1600 lm). This bulb will be screwed into the floor lamp, replacing the inoperable 100 W incandescent bulb.

In a final aspect of the example above, the consumer might have a table lamp with a 60 W incandescent bulb. Their desire is to be able to activate the lamp and accent a room that they may not want to cover with too much light intensity. Therefore, they can return to their pantry, pull out another variable lumen spiral at 800 lumens. This variable lumen spiral is identical to the lamps used in the preceding two examples.

The example above solves the problem of having to purchase three different bulbs at three different wattage levels. Bulbs constructed in accordance with the embodiments also solve the problem of having to use a bulb with the wrong wattage, consequently providing suboptimal performance. A variable lumen spiral, constructed in accordance with the embodiments is also less expensive than other traditional multi-wattage approaches, such as dimming CFL's.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS

The accompanying drawings, which are incorporated herein and form part of the specification, illustrate the present invention and, together with the description, further serve to explain the principles of the invention and to enable a person skilled in the relevant art(s) to make and use the invention.

FIG. 1 is an illustration of a conventional CFL including a dimmer switch.

FIG. 2 is an illustration of a variable lumen CFL constructed in accordance with a first embodiment of the present invention.

FIG. 3 is an illustration of a variable lumen CFL constructed in accordance with a second embodiment of the present invention.

FIG. 4 is a more detailed illustration of aspects of the variable lumen CFL illustrated in FIG. 3.

FIG. 5 is a block diagram illustration of major circuit components of a conventional lighting assembly.

FIG. 6 is a block diagram illustration of major circuit components of the variable lumen CFL illustrated in FIG. 2.

FIG. 7 is a block diagram illustration of major circuit components of a variable lumen lamp assembly constructed in accordance with a third embodiment of the present invention.

FIG. 8 is an illustration of a switch configured for use with the variable lumen lamp assembly illustrated in FIG. 7.

FIG. 9 is a schematic circuit diagram of major circuit components of a variable lumen lamp assembly constructed in accordance with a fourth embodiment of the present invention.

### DETAILED DESCRIPTION OF EMBODIMENTS OF THE INVENTION

While the present invention is described herein with illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

Embodiments of the present invention provide a multi-lumen level CFL that is technically unsophisticated, simple, and easily manufactured. The exemplary embodiments provide a mainstream bulb that should be relatively easy to introduce into the market.

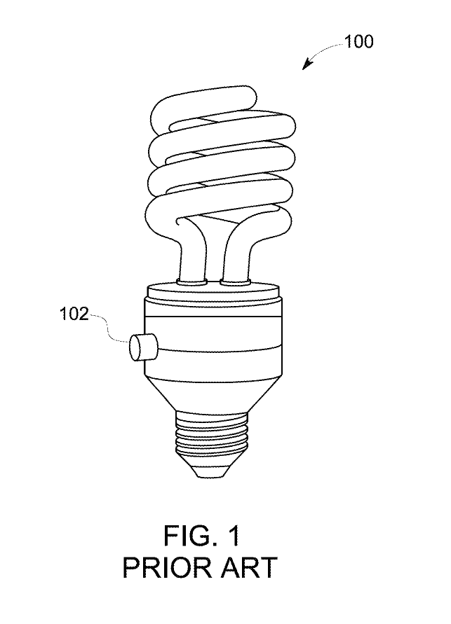

As noted above, a popular approach to multi-wattage lighting solutions includes dimmer CFLs. FIG. 1 is an illustration of a conventional dimmer CFL 100 including an integrated dimmer switch 102. Without the use of any other external device, voltages applied to the CFL 100 can be increased or decreased by turning the dimmer switch 102. Dimmer CFL's, such as the conventional CFL 100, tend to be expensive in comparison to variable lumen lamps constructed in accordance with the embodiments.

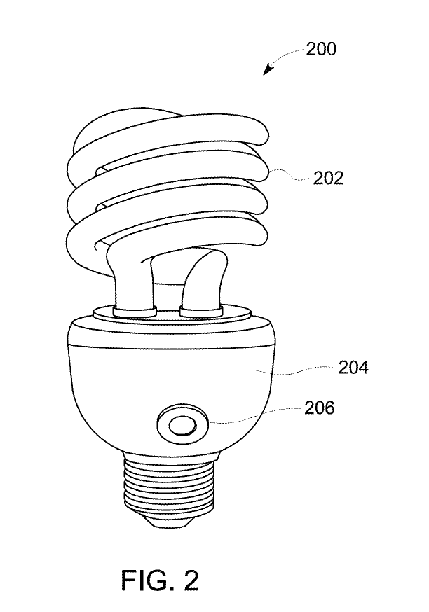

FIG. 2 is an illustration of an exemplary variable lumen CFL 200 constructed in accordance with a first embodiment of the present invention. The variable lumen CFL 200 includes a single spiral fluorescent light tube 202 and a lamp base enclosure 204. The lamp base enclosure 204 includes ballast circuitry (not shown) for starting and regulating the spiral fluorescent light tube 202. Also included is a manual switchboard 206 for dialing one of a number of predetermined output wattage settings, discussed more fully below.

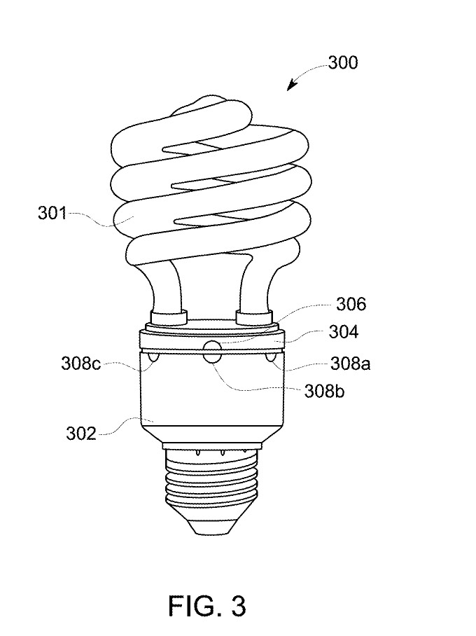

FIG. 3 is an illustration of a variable lumen CFL 300 constructed in accordance with a second embodiment of the present invention. The variable lumen CFL 300 includes a fluorescent light tube 301 and a lamp base enclosure 302 that includes ballast circuitry (not shown). The CFL 300 includes a cylindrical dial 304. The cylindrical dial 304 enables a consumer, using a marker 306, to select between predetermined wattage/lumen settings 308a, 308b, and 308c.

As shown in FIG. 3, settings 308a-308c correspond to output wattage/lumen settings 23 W/1700 lumens, 20 W/1170 lumens, and 13 W/840 lumens, respectively. In the exemplary illustration of FIG. 3, the marker 306 is aligned with output wattage lumen/wattage setting 308b, which sets the CFL 300 to 20 W/1170 lumens.

As well understood by those of skill in the art, CFL's are made of glass, a ceramic and metal base, phosphor, and a small amount of mercury. The phosphor in the CFL's can be used to provide various colour temperature variations. By way of example, and as also understood by those of skill in the art, a Kelvin scale is often used in the measure of the colour temperature of light sources. In the Kelvin scale, for example, a colour temperature of the CFL 300 can be soft white. Soft white is about 2700 Kelvin. A colour temperature referred to herein as daylight, for example, might equate to about 6500 Kelvin.

Within this range, there are about three different colour temperature levels that can be provided in a CFL depending on a variety of factors and consumer preferences.

Using dimmer CFL's, for example, it is difficult to obtain all of the different colour temperatures, especially when combined with different wattages. Such combinations would produce too many SKUs and too much inventory to be commercially practical.

Using CFL's constructed in accordance with the present invention, opportunities are presented for retailers to provide a wider variety of color solutions within the CFL spirals by combining the various wattages into one bulb. Although the exemplary CFL 300 of FIG. 3 is shown to be soft white, other achievable colour temperatures and referred to herein as daylight, sunshine, cool white, and the like. Dial markers, such as the marker 306, can be used to produce colors representative of the CFL colour temperature.

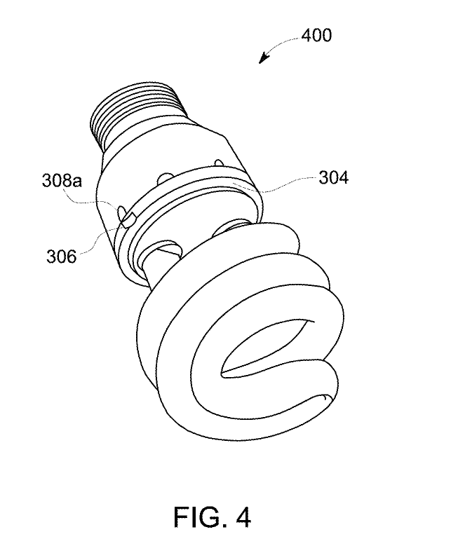

FIG. 4 is a more detailed illustration of aspects of the variable lumen CFL 300 illustrated in FIG. 3. Shown in FIG. 4 are more detailed views of the dial 304, the marker 306, and the lumen/wattage setting 308a. Although the exemplary CFLs 300 and 400 use a manual switchboard and a cylindrical dial, many other lumen/wattage selector mechanisms (i.e., switches) would be suitable for use with the embodiments and are within the spirit and scope of the present invention.

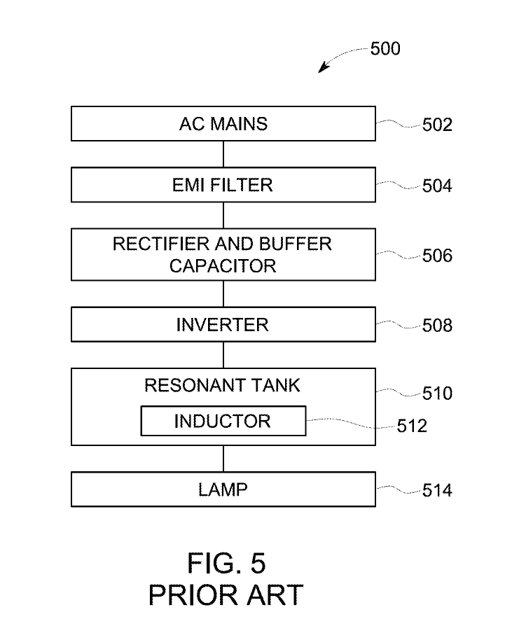

FIG. 5 is a block diagram illustration of a circuit board 500 including major circuit components of a conventional CFL lighting assembly. By way of background, the circuit board 500 includes a main AC power supply 502, an electromagnetic interference (EMI) filter 504, a rectifier and buffer capacitor 506, and an inverter 508. The purpose and utility of the components 502-508 are not unique to the description of the embodiments of the present invention and are well understood by those of skill in the art. Therefore, the components 502-508 will not be described in additional detail herein.

The circuit board 500 also includes a resonant tank (inductor 512 +capacitor (not shown)) 510. The inductor 512, typically placed in series with a lamp 514, is used to set the power level of the lamp. More specifically, the inductor 512 regulates the power supplied to the lamp 514. The higher the inductance of the inductor 512, the lower the value of the power supplied to the lamp 514. More specifically, the inductor 512 functions as a current limiter choke and a resonant inductor.

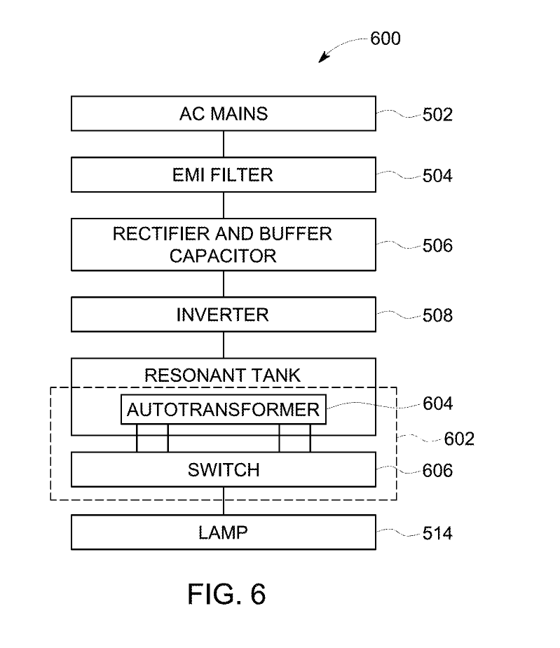

FIG. 6 is a block diagram illustration of a circuit board 600 including major circuit components of the variable lumen CFL illustrated in FIG. 2. In the exemplary embodiment of FIG. 6, components 502-508 in the circuit board 600 function in a manner identical to its corresponding component in the circuit board 500 of FIG. 5. Unique to the embodiments of the present invention, however, resonant tank 510 of FIG. 5 is replaced with switching circuitry 602.

The switching circuitry 602 includes a resonant tank autotransformer 604 and a switch 606. The resonant tank autotransformer 604 raises and lowers a percentage of the voltage supplied to the lamp 514. The switch 606 enables a user to adjust the percentages of the supply voltage applied to the lamp 514. Exemplary implementations of the switch 606 are shown above in the form of the manual switchboard 206 and the dial 304 of FIGS. 2 and 3, respectively. As also mentioned, however, the embodiments are not limited to these particular switch implementations.

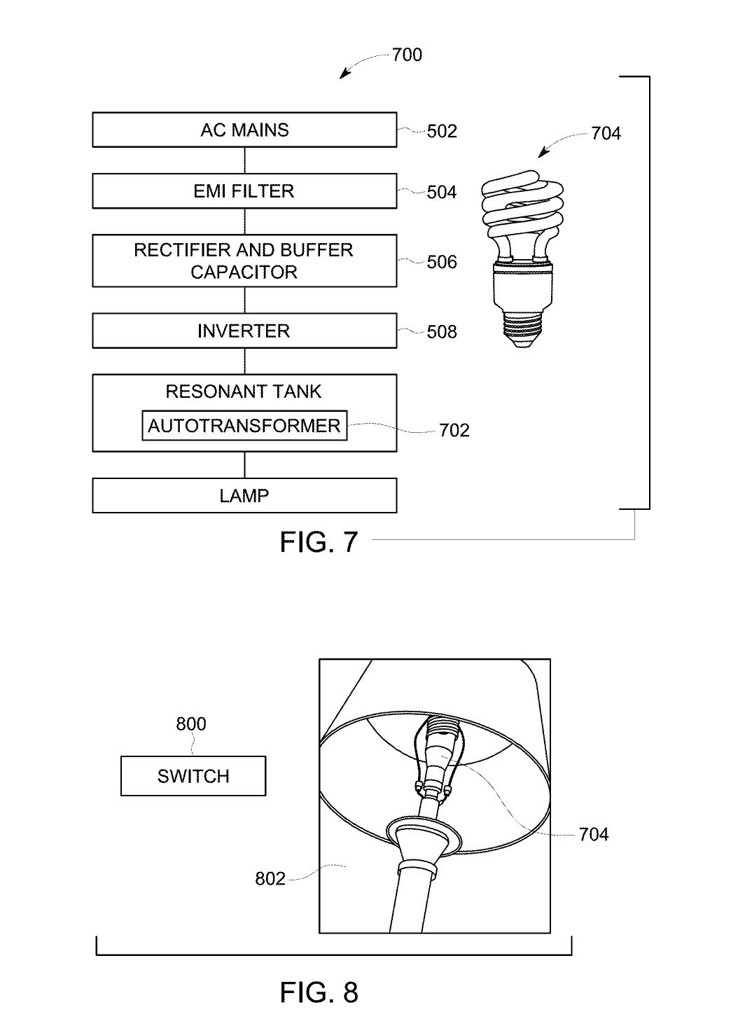

FIG. 7 is a block diagram illustration of a circuit board 700 including major circuit components of a variable lumen lamp assembly constructed in accordance with a third embodiment of the present invention. In FIG. 7, only a resonant tank autotransformer 702 is physically housed within the circuit board 700—not a switch. In the illustration the FIG. 7 a spiral CFL 704 can be modified to include only the resonant tank autotransformer 702. The spiral CFL 704 is devoid of a lumen/wattage switch. In the embodiment of FIG. 7, a switch (not shown) can be housed separately or remotely from the circuit board 700. Although not permanently and physically connected to the resonant tank autotransformer 702, during operation, the switch will be electrically and operably connected to the autotransformer 702.

FIG. 8 is an illustration of a switch 800 configured for use with the variable lumen lamp assembly illustrated in FIG. 7. In FIG. 8, the switch 800 can be permanently and physically mounted on a lamp 802. During operation, the spiral CFL 704 the screwed into the socket of the lamp 802, having the switch 800 attached thereto. A user selects between the different lumen/wattage settings by bowing the settings on the lamp 802 using the switch 800, which dials and/or selects the various settings associated with the resonant tank autotransformer 702.

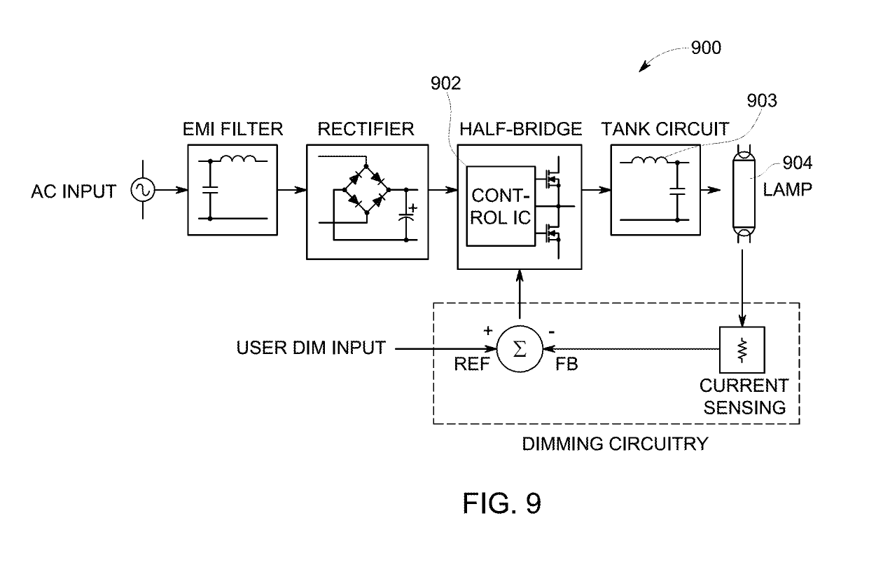

FIG. 9 is a schematic circuit diagram 900 including components of a variable lumen lamp assembly constructed in accordance with a fourth embodiment of the present invention. The schematic diagram 900 includes, among other things, a control integrated circuit (IC) 902, a tank circuit including an inductor 903, and a lamp 904. An output wattage of the lamp 904 can be changed by adjusting a frequency of the lamp 904 without changing a value of the inductor 903.

### CONCLUSION

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

For example, various aspects of the present invention can be implemented by software, firmware, hardware (or hardware represented by software such, as for example, Verilog or hardware description language instructions), or a combination thereof. After reading this description, it will become apparent to a person skilled in the relevant art how to implement the invention using other computer systems and/or computer architectures.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

What is claimed is:

1. A lamp assembly, comprising:
a bulb;
a lamp base enclosure having circuitry therein configured to supply power to the bulb; and
a dial electrically coupled to the bulb and the lamp base;
wherein the dial is operable for selecting one of a plurality of predetermined power settings.

2. The lamp assembly of claim 1, wherein the assembly includes a compact fluorescent lamp (CFL).

3. The lamp assembly of claim 1, wherein the bulb is a fluorescent lamp.

4. The lamp assembly of claim 3, wherein the fluorescent lamp is a single spiral light tube.

5. The lamp assembly of claim 1, wherein the lamp base includes a ballast.

6. The lamp assembly of claim 1, wherein the dial is affixed to an exterior of the enclosure.

7. The lamp assembly of claim 1, wherein the dial includes an autotransformer and a switch.

8. The lamp assembly of claim 1, wherein the dial includes at least one from the group including a manual switchboard and a multi-position switch.

9. The lamp assembly of claim 1, wherein the predetermined power settings include wattage or lumens.

10. The lamp assembly of claim 9, wherein the dial includes values for conversion from wattage to lumens.

11. The lamp assembly of claim 10, wherein the predetermined power settings are representative of color temperatures.

12. A lamp assembly, comprising:
a bulb;
lamp base circuitry configured to supply power to the bulb; and
a dial electrically coupled to the bulb and the lamp base, the dial being operable for selecting one of a plurality of predetermined power settings.

13. A switching circuit operable for controlling an application of power to a bulb positioned within a light socket, the switching circuit comprising:
a transformer for regulating the supply of power to the bulb; and
a dial configured to be electrically coupled to the transformer, the dial being operable for selecting one of a plurality of predetermined values of the power.

14. The switching circuit of claim 13, wherein the bulb is a compact fluorescent lamp (CFL).

15. The switching circuit of claim 13, wherein the switching circuit is configured to be coupled to at least one from the group including the bulb and a lighting fixture.

16. The switching circuit of claim 15, wherein the dial is affixed to an exterior of the lighting fixture.

17. The switching circuit of claim 16, wherein the dial includes multiple positions.

18. The switching circuit of claim 13, wherein the transformer is an autotransformer.

19. The switching circuit of claim 13, wherein the values of power are adjustable over a range of about 40 percent

20. The switching circuit of claim 13, wherein the dial and the transformer are not physically connected.
